(19) United States
(12) Patent Application Publication
(10) Pub. No.: US 2025/0385248 A1
(43) Pub. Date: Dec. 18, 2025

(54) METHOD FOR MANUFACTURING LCO@OXIDE@CNT MULTICOMPOSITE CATHODE MATERIAL

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen (CN)

(21) Appl. No.: 18/740,551

(22) Filed: Jun. 12, 2024

(51) Int. Cl. H01M 4/36; H01M 4/02; H01M 4/04; H01M 4/525; H01M 4/62

(52) U.S. Cl. CPC H01M 4/364; H01M 4/0471; H01M 4/366; H01M 4/525; H01M 4/625; H01M 2004/021; H01M 2004/028

(57) ABSTRACT

A method for manufacturing a LCO@oxide@CNT multicomposite cathode material comprises the following step of: mixing a LLZO material and a plurality of large LCO (LiCoO₂) particles to form a plurality of composite LCO particles, wherein the LLZO material is formed by a LLZO (Li₇La₃Zr₂O₁₂) or a LLZO doped with at least one metal. The LLZO material includes a plurality of large LLZO particles and small LLZO particles. Then an oxygen assisted sintering is performed on the composite LCO particles to form a plurality of sintered powders. A first LLZO interphase layer is formed between each large LLZO particle and the respective large LCO particle. A second LLZO interphase layer is formed between each small LLZO particle and the respective large LCO particle. Then the sintered powders are mixed with a plurality of first carbon nanotubes.

### FIELD OF THE INVENTION

The present invention is related to a positive electrode material of a battery, and in particular to a method for manufacturing a LCO@oxide@CNT multicomposite cathode material.

### BACKGROUND OF THE INVENTION

A typical battery includes a positive electrode and a negative electrode. A cathode of the battery is the positive electrode inside the battery. The positive electrode mainly comprises a positive substrate and a positive slurry layer coated on the positive substrate. The positive slurry layer includes a positive slurry having a binding agent and a plurality of positive particles. The positive particles are mainly used in the positive electrode of general solid-state or semi-solid batteries. Positive particles must be either additionally conductive or electrically conductive in order to allow free electrons to migrate through the positive slurry without consuming too much energy due to internal resistance, which achieves effective conductivity. Therefore, specific conductive materials for regulating the conductivity of positive particles must be taken into account in the manufacturing of positive particles.

Traditionally, the positive particles can be made of LCO (lithium cobalt oxide), LMFP (Lithium Manganese Iron Phosphate), or mixtures thereof, which are distributed within the positive slurry. There are many known techniques to improve the conductivity of lithium ions in the positive particles made of these materials, but it is still considered that the conductivity of lithium batteries is not sufficient for practical use. Therefore, it is necessary to carry out some material modifications to further improve the conductivity of the positive particles.

Based on the experience with battery materials, the applicant of the present invention desires to provide a novel invention that enables the positive electrode of solid-state batteries to have higher electrical capacity and conductivity for further enhancing the performance of the batteries.

### SUMMARY OF THE INVENTION

Accordingly, for improving above mentioned defects in the prior art, the object of the present invention is to provide a method for manufacturing a LCO@oxide@CNT multicomposite cathode material, wherein the cathode material is a positive electrode material of a positive electrode inside a battery. The surface of the large LCO particles is coated with large and small LLZO particles and a interphase layer to form composite LCO particles, which enhances ionic conductivity and protection. Since electron transferring and ion transferring are interdependent, in order to solve the problem that the ceramic nature of the above oxides reduces a part of conductivity of electrons, the outer side of the composite LCO particles is further wrapped with an electron-conducting dielectric, which is a conductive network consisting of short chain and long chain carbon nanotubes with various lengths. The short chain carbon nanotubes provide capability of transferring short-range electron to conduct electrons for making lithium ion transfer easier, while the long chain carbon nanotubes provide capability of transferring the electron between various large and small LLZO particles, the composite LCO particles, and the other materials in the positive electrode substrate, so as to form a small electron transfer chain to promote transferring of ions, and thus improve transferring of electron and ion throughout the entire positive electrode. The wrapping of the carbon nanotubes and the large and small LLZO particles also makes lithium ions less likely to be blocked on the surface of the positive electrode due to poor transmission, and avoids to be combined with the electrolyte to form lithium consumption products such as SEI (Solid Electrolyte Interface). Therefore, it improves the overall lifespan of positive electrode, that is, the cycling performance. The positive electrode material of the present invention also achieves better multiplication performance with the better transfer chain of the lithium ion and electron. By the improving of the transferring of ion and electron in the positive electrode, the side reaction is decreased and the LLZO particles and the interphase layer provide more protection, so that the overall positive electrode is not easy to react with the electrolyte, and is also not easy to be affected by the side reaction after the electrolyte disintegrates and reacts with the positive electrode under a high voltage. As a result, the present invention improves the voltage resistance performance and enables it to be charged and discharged in a range of 4.7V˜4.9V, and reduces the behavior of high pressure oxygen releasing and gas producing of the positive electrode, which enhances the overall safety.

To achieve above object, the present invention provides a method for manufacturing a LCO@oxide@CNT multicomposite cathode material, wherein the cathode material is a positive electrode material of a positive electrode inside a battery and the positive electrode material is a plurality of positive particles; the oxide is a LLZO (lithium lanthanum zirconium oxide, Li₇La₃Zr₂O₁₂) or a LLZO doped with at least one metal; and the positive particles are used in a positive electrode of a solid-state battery or a semi-solid battery; the method comprising the following steps of: step A: mixing a LLZO material and a plurality of large LCO (lithium cobalt oxide, LiCoO₂) particles to form a plurality of composite LCO particles, wherein the LLZO material is formed by a LLZO (lithium lanthanum zirconium oxide, Li₇La₃Zr₂O₁₂) or a LLZO doped with at least one metal; wherein a size of each of the large LCO particles being 10 μm to 15 μm; each of the large LCO particles being a cube having an irregular shape; the LLZO material including a plurality of large LLZO particles and a plurality of small LLZO particles; a size of each of the large LCO particles being larger than a size of each of the large LLZO particles; and the size of each of the large LLZO particles being larger than a size of each of the small LLZO particles; step B: performing an oxygen assisted sintering on the composite LCO particles to form a plurality of sintered powders which are the positive particles; and wherein after the oxygen assisted sintering, in each of the composite LCO particles, each of the corresponding large LLZO particles forms a first protruded portion on a surface of the respective large LCO particle, wherein a center of the first protruded portion is higher than a flat outer side of the protruded portion; a first LLZO interphase layer is formed between a bottom of each of the corresponding large LLZO particles and the respective large LCO particle; the first LLZO interphase layer is formed by a plurality of compounds containing a LLZO or a LLZO doped with at least one metal, cobalt-contained compounds and cobalt derivatives, wherein the cobalt is on an outer layer of the respective large LCO particle; wherein in each of the composite LCO particles, each of the corresponding small LLZO particles forms a second protruded portion on the surface of the respective large LCO particle, wherein a center of the second protruded portion is higher than a flat outer side of the second protruded portion; a second LLZO interphase layer is formed between a bottom of each of the corresponding small LLZO particles and the respective large LCO particle; the second LLZO interphase layer is formed by a plurality of compounds containing a LLZO or a LLZO doped with at least one metal, a cobalt-contained compounds and cobalt derivatives, wherein the cobalt is on an outer layer of the respective large LCO particle; step C: placing the sintered powders and a plurality of first carbon nanotubes (CNT) into a second mixer for mixing, wherein an outer surface of each of the composite LCO particles is wrapped by a plurality of corresponding first carbon nanotubes; the corresponding first carbon nanotubes being randomly distributed on the outer surface of the respective composite LCO particle; and wherein the first carbon nanotubes have various lengths to form a plurality of connections with different spanning lengths on each of the composite LCO particle; the first carbon nanotubes serve to be connected across between the respective large LLZO particle and the respective large LCO particle, or to be connected across between the respective small LLZO particle and the respective large LCO particle, or to cover each of the composite LCO particles.

### BRIEF DESCRIPTION OF THE DRAWINGS

FIG. 1 is a steps flow diagram showing the process of the present invention.

FIG. 2 is a schematic view showing the structure of the present invention.

FIG. 3 is a schematic view showing the embodiment of the present invention.

FIG. 4 is an enlarged schematic view showing the structure of the present invention.

FIG. 5 is another enlarged schematic view showing the structure of the present invention.

FIG. 6 is schematic view showing the wrapping of the short chain carbon nanotubes of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

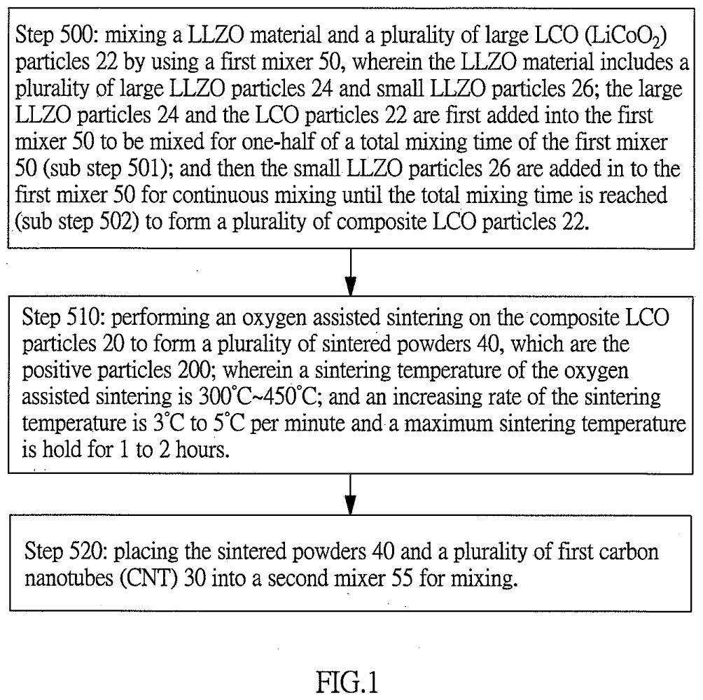

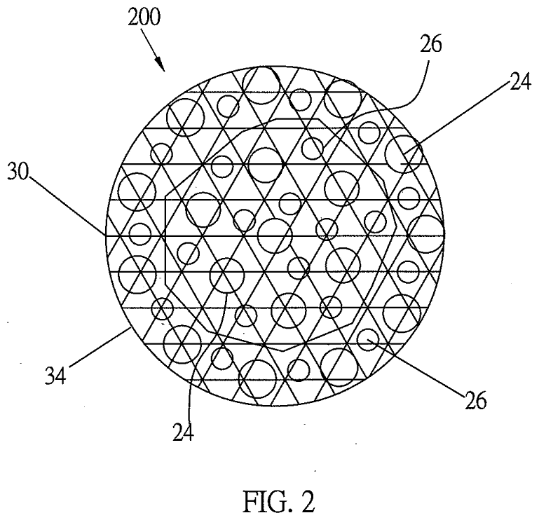

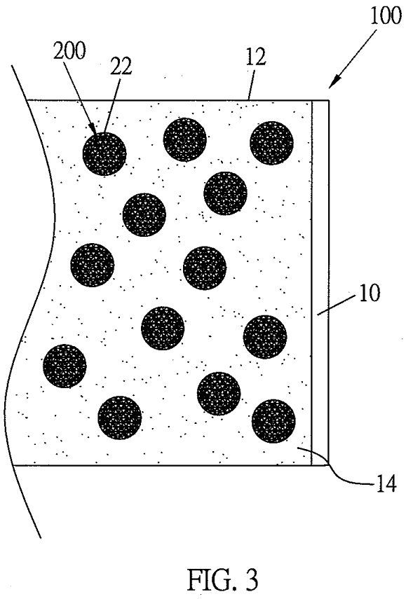

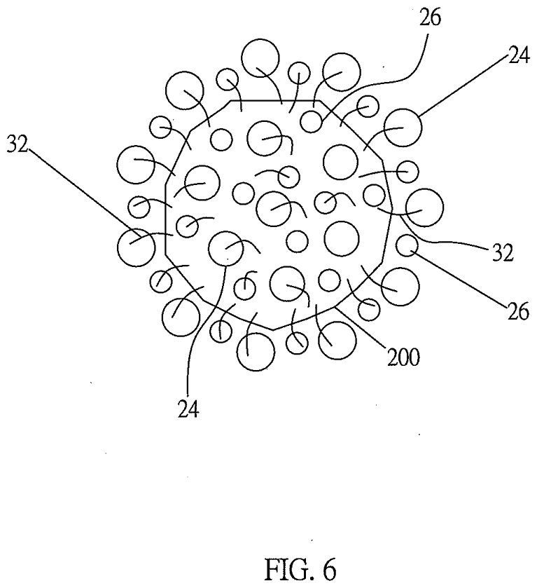

With reference to FIGS. 1 to 6, the present invention provides a method for manufacturing a LCO@oxide@CNT multicomposite cathode material, wherein the cathode material is a positive electrode material of a positive electrode 100 inside a battery and the positive electrode material is presented as a plurality of positive particles 200. The oxide is a LLZO (lithium lanthanum zirconium oxide, Li₇La₃Zr₂O₁₂) or a LLZO doped with The positive particles 200 are used in a positive at least one metal. electrode of a solid-state or semi-solid battery. The positive electrode 100 includes a positive substrate 10 (as shown in FIG. 3) and a positive slurry layer 12 coated on the positive substrate 10. The positive slurry layer 12 includes the plurality of positive particles 200 and a positive slurry 14 with a binder. A weight percentage of the plurality of positive particles 200 in the positive slurry layer 12 is 92 wt %˜98 wt %.

Referring to FIG. 1, the method for manufacturing the positive electrode material (the plurality of positive particles 200) comprises the following steps of:

Mixing a LLZO material and a plurality of large LCO (lithium cobalt oxide, LiCoO₂) particles 22 (step 500) to form a plurality of composite LCO particles 20. In the present invention, the LLZO material is formed by a LLZO (lithium lanthanum zirconium oxide, Li₇La₃Zr₂O₁₂) or a LLZO doped with at least one metal. A size of each of the large LCO particles 22 is 10 μm to 15 μm. Each of the large LCO particles 22 is a cube having an irregular shape. The LLZO material includes a plurality of large LLZO particles 24 and a plurality of small LLZO particles 26. A size of each of the large LCO particles 22 is larger than a size of each of the large LLZO particles 24. The size of each of the large LLZO particles 24 is larger than a size of each of the small LLZO particles 26.

The large LLZO particles 24, the small LLZO particles 26 and the LCO particles 22 are uniformly mixed by a sufficient mixing of a first mixer 50. The first mixer 50 is selected from a three dimensional mixer and a flat 4 roller mixer.

The step 500 includes a sub step 501 and a sub step 502. In the sub step 501, in the mixing of the first mixer 50, the large LLZO particles 24 and the LCO particles 22 are first added into the first mixer 50 to be mixed for one-half of a total mixing time of the first mixer 50, and then in the step 502, the small LLZO particles 26 are added into the first mixer 50 for continuous mixing until the total mixing time of the first mixer 50 is reached. A rotation speed of the first mixer 50 is 50 rpm˜100 rpm. The total mixing time of the first mixer 50 is 8 to 12 hours. After the mixing of the first mixer 50, the large LLZO particles 24, the small LLZO particles 26 and the LCO particles 22 are mixed to form the composite LCO particles 20. Each of the composite LCO particles 20 includes a respective one LCO particle 22, a plurality of corresponding large LLZO particles 24 and a plurality of corresponding small LLZO particles 26. A surface of each of the LCO particles 22 is coated by the corresponding large LLZO particles 24 and the corresponding small LLZO particles 26. A horizontal size of each of the large LLZO particles 24 is 100 nm˜200 nm, wherein the horizontal size is a size of the large LLZO particle 24 on a horizontal direction corresponding to a spherical surface of the respective large LCO particles 22. A horizontal size of each of the small LLZO particles 26 is less than 50 nm, wherein the horizontal size is a size of the small LLZO particle on the horizontal direction corresponding to the spherical surface of the respective large LCO particles 22.

In each of the composite LCO particles 20, a ratio of a total weight of the corresponding large LLZO particles 24 and a weight of the respective large LCO particle 22 is 0.5%˜0.8%, and a ratio of a total weight of the corresponding small LLZO particles 26 and the weight of the respective large LCO particle 22 is 0.1%˜0.3%.

Since that the large LLZO particles 24 cannot cover the corresponding large LCO particle 22 well and result in many gaps, it is necessary to fill the gaps between the large LLZO particles 24 by using the small LLZO particles 26, which can achieve a more robust process and a better surface coverage.

Performing an oxygen assisted sintering on the composite LCO particles 20 to form a plurality of sintered powders 40, which are the positive particles 200 (step 510). A sintering temperature of the oxygen assisted sintering is 300° C.˜450° C. An increasing rate of the sintering temperature is 3° C. to 5° C. per minute and a maximum sintering temperature is hold for 1 to 2 hours. After the oxygen assisted sintering, a vertical size of each of the large LLZO particles 24 is decreased, wherein the vertical size of the large LLZO particle 24 is a size on a direction perpendicular to the horizontal direction corresponding to the spherical surface of the respective large LCO particle 22. A vertical size of each of the small LLZO particles 26 is decreased, wherein the vertical size of the small LLZO particle 26 is a size on a direction perpendicular to the horizontal direction corresponding to the spherical surface of the respective large LCO particle 22. The horizontal size of each of the large LLZO particles 24 and the small LLZO particles 26 is increased. A volume of each of the large LLZO particles 24 and the small LLZO particles 26 remains unchanged.

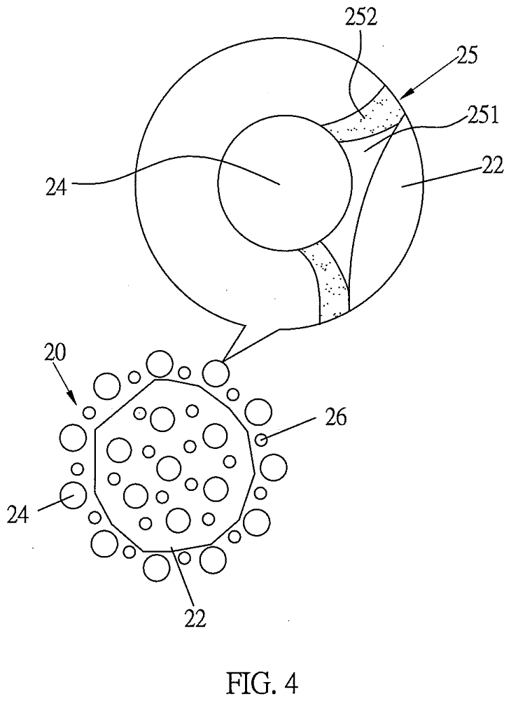

In each of the composite LCO particles 20, each of the corresponding large LLZO particles 24 forms a first protruded portion on the surface of the respective large LCO particle 22. As shown in FIG. 4, a center of the first protruded portion is higher than a flat outer side of the first protruded portion. A cross section of the first protruded portion has a curved contour on the surface of the respective large LCO particle 22. A first LLZO interphase layer 25 is formed between a bottom of each of the corresponding large LLZO particles 24 and the respective large LCO particle 22. The first LLZO interphase layer 25 is formed by a plurality of compounds containing “a LLZO or a LLZO doped with at least one metal”, cobalt-contained compounds and cobalt derivatives, wherein the cobalt is on an outer layer of the respective large LCO particle 22. The first LLZO interphase layer 25 serves to provide better guiding channels for lithium ions. An interphase thickness of the first LLZO interphase layer 25 is 2 nm˜12 nm.

The first LLZO interphase layer 25 includes a first oxygen-deficiency interface layer 251 and a first derivative layer 252 which are formed in the oxygen assisted sintering performed on the respective large LLZO particles 24 and the respective large LCO particle 22. The first oxygen-deficiency interface layer 251 is formed by a lanthanum zirconate (La₂Zr₂O₇) and a lanthanum(III) oxide (La₂O₃). The first derivative layer 252 is formed by a lithium phosphate (Li₃PO₄). A sum of a thickness of the first oxygen-deficiency interface layer 251 and a thickness of the first derivative layer 252 is 1 nm˜10 nm. The first LLZO interphase layer 25 facilitates a connection between the respective large LLZO particle 24 and the respective large LCO particle 22 to form a continuous interface. The first derivative layer 252 has an ability of conducting lithium (Li) ions, which is slightly inferior to that of the large LLZO particle 24. The first oxygen-deficiency interface layer 251 serves as an ion-conductive connection layer and provides a protection for the large LCO particle 22. The first derivative layer 252 forms a thin film by deriving on a surface of the respective large LLZO particle 24, a surface of the respective small LLZO particle 26 and a surface of the respective large LCO particle 22.

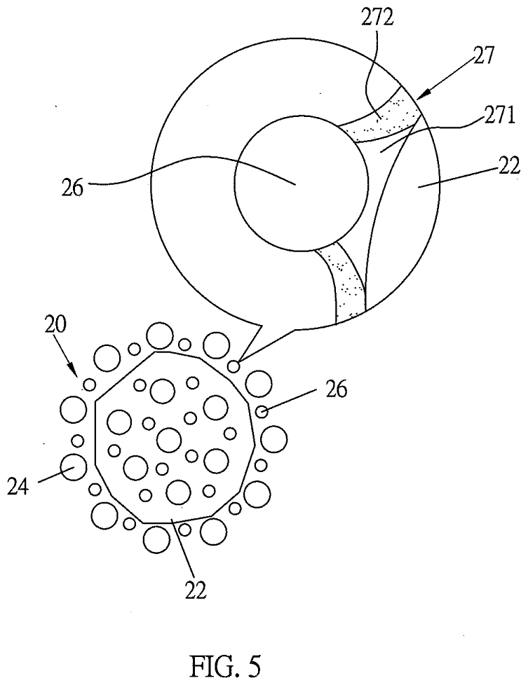

In each of the composite LCO particles 20, each of the corresponding small LLZO particles 26 forms a second protruded portion on the surface of the respective large LCO particle 22. As shown in FIG. 5, a center of the second protruded portion is higher than a flat outer side of the second protruded portion. A cross section of the second protruded portion has a curved contour on the surface of the respective large LCO particle 22. A second LLZO interphase layer 27 is formed between a bottom of each of the corresponding small LLZO particles 26 and the respective large LCO particle 22. The second LLZO interphase layer 27 is formed by a plurality of compounds containing “a LLZO or a LLZO doped with at least one metal”, a cobalt-contained compounds and cobalt derivatives, wherein the cobalt is on an outer layer of the respective large LCO particle 22. The second LLZO interphase layer 27 serves to provide better guiding channels for lithium ions. An interphase thickness of the second LLZO interphase layer 27 is 2 nm˜12 nm.

The second LLZO interphase layer 27 includes a second oxygen-deficiency interface layer 271 and a second derivative layer 272 which are formed in the oxygen assisted sintering performed on the respective small LLZO particles 26 and the respective large LCO particle 22. The second oxygen-deficiency interface layer 271 is formed by a lanthanum zirconate (La₂Zr₂O₇) and a lanthanum(III) oxide (La₂O₃). The second derivative layer 272 is formed by a lithium phosphate (Li₃PO₄). A sum of a thickness of the second oxygen-deficiency interface layer 271 and a thickness of the second derivative layer 272 is 1 nm˜10 nm. The second LLZO interphase layer 27 facilitates a connection between the respective small LLZO particle 26 and the respective large LCO particle 22 to form a continuous interface. The second derivative layer 272 has an ability of conducting lithium (Li) ions, which is slightly inferior to that of the small LLZO particle 26. The second oxygen-deficiency interface layer 271 serves as an ion-conductive connection layer for ion conduction and provides a protection for the respective large LCO particle 22. The second derivative layer 272 forms a thin film by deriving on a surface of the respective large LLZO particle 24, a surface of the respective small LLZO particle 26 and a surface of the respective large LCO particle 22.

The first and second LLZO interphase layers 25, 27 form connections between the LLZO material and LCO. The more complete the covering of the large LLZO particles 24 and the small LLZO particles 26 on the respective large LCO particle 22, the less surface of the large LCO particle 22 is exposed, which reduces the rate and amount of side reactions with the electrolyte or colloidal materials and makes the positive electrode material more stable. The La₂Zr₂O₇ also has a capability of conducting lithium (Li) ions, which is not as good as that of the LLZO material, but it can be used as an ion-conducting layer to help conduct lithium ions from the LCO to the LLZO material. The LLZO material is used as a fast tunnel for conducting the lithium ions, allowing the lithium ions from the LCO to migrate out and in quickly and efficiently through the first and second LLZO interphase layers 25, 27 to the LLZO material. The La₂Zr₂O₇ further has an inert in a ceramic compound, which reduces the side reaction between the positive electrode and the electrolyte. Especially at a high voltage (greater than 4.5V or even 4.9V), the first and second LLZO interphase layers 25, 27 provide a passivation and a protection for the LCO.

Placing the sintered powders 40 and a plurality of first carbon nanotubes (CNT) 30 into a second mixer 55 for mixing (step 520). A rotation speed of the second mixer 55 is 50 rpm˜150 rpm and a mixing time of the second mixer 55 is 3 hours to 6 hours. The second mixer 55 is selected from a planetary mixer and a tumbler mixer.

In the present invention, there are two types of the mixer 55, a wet mixer (e.g. a planetary mixer) and a dry mixer (e.g. a three-dimensional mixer). The wet mixer is more effective, but requires a drying operation to remove a moisture.

The first carbon nanotubes 30 include a plurality of short chain carbon nanotubes 32 and a plurality of long chain carbon nanotubes 34. A length of each of the short chain carbon nanotubes 32 is 0.5 μm to 3 μm. A length of each of the long chain carbon nanotubes 34 is 8 μm to 12 μm. A ratio of a total weight of the short chain carbon nanotubes 32 and a total weight of the long chain carbon nanotubes 34 is 5:2. A ratio of a total weight of the first carbon nanotubes 30 and a total weight of the large LCO particles 22 is 0.01%˜0.5%.

After the mixing of the step 520, an outer surface of each of the composite LCO particles 20 is wrapped by a plurality of corresponding first carbon nanotubes 30, wherein the corresponding first carbon nanotubes 30 are randomly distributed on the outer surface of the respective composite LCO particle 20. After the step 520, a size of each of the composite LCO particle 20 is 10 μm to 15 μm. The horizontal size of each of the large LLZO particles 24 is 100 nm˜280 nm. The horizontal size of each of the small LLZO particles 26 is 50 nm˜100 nm.

The first carbon nanotubes 30 have various lengths to form a plurality of connections with different spanning lengths on each of the composite LCO particle 20. Each of the short chain carbon nanotubes 32 is connected across between the respective large LLZO particle 24 and the respective large LCO particle 22, or is connected across between the respective small LLZO particle 26 and the respective large LCO particle 22. The long chain carbon nanotubes 34 cover each of the composite LCO particles 20 including the short chain carbon nanotubes 32 to enhance a structural strength of each of the composite LCO particles 20. A carbon nanotube is a very good conductive material. Each of the composite LCO particles 20 covered by the corresponding first carbon nanotubes 30 forms a hairball-like structure.

The first carbon nanotubes 30 serve to increase the electrical conductance of the electron by forming a plurality of conductive bridges around the large LLZO particles 24 and the small LLZO particles for conducting the electron on each of the composite LCO particles 20. The first carbon nanotubes 30 have an extremely high electrical conductivity, so that lithium ions can pass through the first carbon nanotubes 30 and conduct between the large LLZO particles 24, the small LLZO particles 26 and the large LCO particles 22, which increase the electrical conductivity of the entire positive electrode 100.

Preferably, the LLZO material is formed by at least one of a LLZO (Li₇La₃Zr₂O₁₂), a Ga-LLZO (gallium-doped LLZO), a Cu-LLZO (copper-doped LLZO), a Ta-LLZO (tantalum-doped LLZO), a Sr-LLZO (strontium-doped LLZO) and an Al-LLZO (aluminum-doped LLZO).

Preferably, the LLZO material is formed by a Cuₐ,X_{b}-LLZO, which is a LLZO doped with copper (Cu) and a metal X, wherein X is selected from gallium (Ga), tantalum (Ta), strontium (Sr), barium (Ba) and aluminum (Al), and a>0 and b>0. Preferably, a+b=0.25˜0.8 and a>0.1. Doping the copper in the LLZO is technically difficult, but Cuₐ,X_{b}-LLZO can stabilize an overall structure of composite LCO particles, smooth the channels for lithium ions, and increase a speed of the oxygen assisted sintering, which makes the cost more cheaper. It also reduces the producing of lithium carbonate (Li₂CO₃) when the LLZO material is exposed to the air, which increases the surface stability of the LLZO material during the sintering.

The advantages of the present invention are that the surface of the large LCO particles is coated with large and small LLZO particles and a interphase layer to form composite LCO particles, which enhances ionic conductivity and protection. Since electron transferring and ion transferring are interdependent, in order to solve the problem that the ceramic nature of the above oxides reduces a part of conductivity of electrons, the outer side of the composite LCO particles is further wrapped with an electron-conducting dielectric, which is a conductive network consisting of short chain and long chain carbon nanotubes with various lengths. The short chain carbon nanotubes provide capability of transferring short-range electron to conduct electrons for making lithium ion transfer easier, while the long chain carbon nanotubes provide capability of transferring the electron between various large and small LLZO particles, the composite LCO particles, and the other materials in the positive electrode substrate, so as to form a small electron transfer chain to promote transferring of ions, and thus improve transferring of electron and ion throughout the entire positive electrode. The wrapping of the carbon nanotubes and the large and small LLZO particles also makes lithium ions less likely to be blocked on the surface of the positive electrode due to poor transmission, and avoids to be combined with the electrolyte to form lithium consumption products such as SEI (Solid Electrolyte Interface). Therefore, it improves the overall lifespan of positive electrode, that is, the cycling performance. The positive electrode material of the present invention also achieves better multiplication performance with the better transfer chain of the lithium ion and electron. By the improving of the transferring of ion and electron in the positive electrode, the side reaction is decreased and the LLZO particles and the interphase layer provide more protection, so that the overall positive electrode is not easy to react with the electrolyte, and is also not easy to be affected by the side reaction after the electrolyte disintegrates and reacts with the positive electrode under a high voltage. As a result, the present invention improves the voltage resistance performance and enables it to be charged and discharged in a range of 4.7V˜4.9V, and reduces the behavior of high pressure oxygen releasing and gas producing of the positive electrode, which enhances the overall safety.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing a LCO@oxide@CNT multicomposite cathode material, wherein the cathode material is a positive electrode material of a positive electrode inside a battery and the positive electrode material is a plurality of positive particles; the oxide is a LLZO (lithium lanthanum zirconium oxide, Li₇La₃Zr₂O₁₂) or a LLZO doped with at least one metal; and the positive particles are used in a positive electrode of a solid-state battery or a semi-solid battery; the method comprising the following steps of:
step A: mixing a LLZO material and a plurality of large LCO (lithium cobalt oxide, LiCoO₂) particles to form a plurality of composite LCO particles, wherein the LLZO material is formed by a LLZO (lithium lanthanum zirconium oxide, Li₇La₃Zr₂O₁₂) or a LLZO doped with at least one metal; wherein a size of each of the large LCO particles being 10 μm to 15 μm; each of the large LCO particles being a cube having an irregular shape; the LLZO material including a plurality of large LLZO particles and a plurality of small LLZO particles; a size of each of the large LCO particles being larger than a size of each of the large LLZO particles; and the size of each of the large LLZO particles being larger than a size of each of the small LLZO particles;
step B: performing an oxygen assisted sintering on the composite LCO particles to form a plurality of sintered powders which are the positive particles; and
wherein after the oxygen assisted sintering, in each of the composite LCO particles, each of the corresponding large LLZO particles forms a first protruded portion on a surface of the respective large LCO particle, wherein a center of the first protruded portion is higher than a flat outer side of the protruded portion; a first LLZO interphase layer is formed between a bottom of each of the corresponding large LLZO particles and the respective large LCO particle; the first LLZO interphase layer is formed by a plurality of compounds containing a LLZO or a LLZO doped with at least one metal, cobalt-contained compounds and cobalt derivatives, wherein the cobalt is on an outer layer of the respective large LCO particle; wherein in each of the composite LCO particles, each of the corresponding small LLZO particles forms a second protruded portion on the surface of the respective large LCO particle, wherein a center of the second protruded portion is higher than a flat outer side of the second protruded portion; a second LLZO interphase layer is formed between a bottom of each of the corresponding small LLZO particles and the respective large LCO particle; the second LLZO interphase layer is formed by a plurality of compounds containing a LLZO or a LLZO doped with at least one metal, a cobalt-contained compounds and cobalt derivatives, wherein the cobalt is on an outer layer of the respective large LCO particle.

2. The method for manufacturing the LCO@oxide@CNT multicomposite cathode material as claimed in claim 1, wherein in the step A, the large LLZO particles, the small LLZO particles and the LCO particles are uniformly mixed by a mixing of a first mixer to form the composite LCO particles.

3. The method for manufacturing the LCO@oxide@CNT multicomposite cathode material as claimed in claim 2, further comprising the following steps of:
step C: placing the sintered powders and a plurality of first carbon nanotubes (CNT) into a second mixer for mixing, wherein an outer surface of each of the composite LCO particles is wrapped by a plurality of corresponding first carbon nanotubes; the corresponding first carbon nanotubes being randomly distributed on the outer surface of the respective composite LCO particle; and
wherein the first carbon nanotubes have various lengths to form a plurality of connections with different spanning lengths on each of the composite LCO particle; the first carbon nanotubes serve to be connected across between the respective large LLZO particle and the respective large LCO particle, or to be connected across between the respective small LLZO particle and the respective large LCO particle, or to cover each of the composite LCO particles.

4. The method for manufacturing the LCO@oxide@CNT multicomposite cathode material as claimed in claim 3, wherein in the step A, a horizontal size of each of the large LLZO particles is 100 nm˜200 nm, which is a size of the large LLZO particle on a horizontal direction corresponding to a spherical surface of the respective large LCO particle; a horizontal size of each of the small LLZO particles is less than 50 nm, which is a size of the small LLZO particle on the horizontal direction corresponding to the spherical surface of the respective large LCO particle.

5. The method for manufacturing the LCO@oxide@CNT multicomposite cathode material as claimed in claim 3, wherein in each of the composite LCO particles, a ratio of a total weight of the corresponding large LLZO particles and a weight of the respective large LCO particle is 0.5%˜0.8%, and a ratio of a total weight of the corresponding small LLZO particles and the weight of the respective large LCO particle is 0.1%˜0.3%.

6. The method for manufacturing the LCO@oxide@CNT multicomposite cathode material as claimed in claim 3, wherein the first mixer is selected from a three dimensional mixer and a flat 4 roller mixer; wherein in the step A, in the mixing of the first mixer, the large LLZO particles and the LCO particles are first added into the first mixer to be mixed for one-half of a total mixing time of the first mixer, and then the small LLZO particles are added into the first mixer for continuous mixing until the total mixing time of the first mixer is reached; a rotation speed of the first mixer is 50 rpm˜100 rpm; the total mixing time of the first mixer is 8 to 12 hours; after the mixing of the first mixer, the large LLZO particles, the small LLZO particles and the LCO particles are mixed to form the composite LCO particles.

7. The method for manufacturing the LCO@oxide@CNT multicomposite cathode material as claimed in claim 3, wherein in the step B, a sintering temperature of the oxygen assisted sintering is 300° C.˜450° C.; an increasing rate of the sintering temperature is 3° C. to 5° C. per minute and a maximum sintering temperature is hold for 1 to 2 hours; after the oxygen assisted sintering, a vertical size of each of the large LLZO particles is decreased, wherein the vertical size of the large LLZO particle is a size on a direction perpendicular to the horizontal direction corresponding to the spherical surface of the respective large LCO particle; a vertical size of each of the small LLZO particles is decreased, wherein the vertical size of the small LLZO particle is a size on a direction perpendicular to the horizontal direction corresponding to the spherical surface of the respective large LCO particle; the horizontal size of each of the large LLZO particles and the small LLZO particles is increased; a volume of each of the large LLZO particles and the small LLZO particles remains unchanged.

8. The method for manufacturing the LCO@oxide@CNT multicomposite cathode material as claimed in claim 1, wherein an interphase thickness of the first LLZO interphase layer is 2 nm˜12 nm; an interphase thickness of the second LLZO interphase layer is 2 nm˜12 nm.

9. The method for manufacturing the LCO@oxide@CNT multicomposite cathode material as claimed in claim 1, wherein the first LLZO interphase layer includes a first oxygen-deficiency interface layer and a first derivative layer which are formed in the oxygen assisted sintering performed on the respective large LLZO particles and the respective large LCO particle; the first oxygen-deficiency interface layer is formed by a lanthanum zirconate (La₂Zr₂O₇) and a lanthanum(III) oxide (La₂O₃); the first derivative layer is formed by a lithium phosphate (Li₃PO₄); a sum of a thickness of the first oxygen-deficiency interface layer and a thickness of the first derivative layer is 1 nm˜10 nm; the first LLZO interphase layer facilitates a connection between the respective large LLZO particle and the respective large LCO particle to form a continuous interface; and
wherein the second LLZO interphase layer includes a second oxygen-deficiency interface layer and a second derivative layer which are formed in the oxygen assisted sintering performed on the respective small LLZO particles and the respective large LCO particle; the second oxygen-deficiency interface layer is formed by a lanthanum zirconate (La₂Zr₂O₇) and a lanthanum(III) oxide (La₂O₃); the second derivative layer is formed by a lithium phosphate (Li₃PO₄); a sum of a thickness of the second oxygen-deficiency interface layer and a thickness of the second derivative layer is 1 nm˜10 nm; the second LLZO interphase layer facilitates a connection between the respective small LLZO particle and the respective large LCO particle to form a continuous interface; and
wherein the first and second derivative layers have an ability of conducting lithium (Li) ions; and each of the first and second oxygen-deficiency interface layers serves as an ion-conductive connection layer and provides a protection.

10. The method for manufacturing the LCO@oxide@CNT multicomposite cathode material as claimed in claim 3, wherein in the step C, a rotation speed of the second mixer is 50 rpm˜150 rpm and a mixing time of the second mixer is 3 hours to 6 hours; the second mixer is selected from a planetary mixer and a tumbler mixer.

11. The method for manufacturing the LCO@oxide@CNT multicomposite cathode material as claimed in claim 3, wherein the first carbon nanotubes include a plurality of short chain carbon nanotubes and a plurality of long chain carbon nanotubes; each of the short chain carbon nanotubes is connected across between the respective large LLZO particle and the respective large LCO particle, or is connected across between the respective small LLZO particle and the respective large LCO particle; the long chain carbon nanotubes cover each of the composite LCO particles including the short chain carbon nanotubes to enhance a structural strength of each of the composite LCO particles; and
wherein a length of each of the short chain carbon nanotubes is 0.5 μm to 3 μm; and a length of each of the long chain carbon nanotubes is 8 μm to 12 μm.

12. The method for manufacturing the LCO@oxide@CNT multicomposite cathode material as claimed in claim 11, wherein a ratio of a total weight of the short chain carbon nanotubes and a total weight of the long chain carbon nanotubes is 5:2; and a ratio of the total weight of the first carbon nanotubes and a total weight of the large LCO particles is 0.01%˜0.5%.

13. The method for manufacturing the LCO@oxide@CNT multicomposite cathode material as claimed in claim 3, wherein after the step C, a size of each of the composite LCO particle is 10 μm to 15 μm; the horizontal size of each of the large LLZO particles is 100 nm˜280 nm; the horizontal size of each of the small LLZO particles is 50 nm˜100 nm.

14. The method for manufacturing the LCO@oxide@CNT multicomposite cathode material as claimed in claim 1, wherein the LLZO material is formed by at least one of a LLZO (Li₇La₃Zr₂O₁₂), a Ga-LLZO (gallium-doped LLZO), a Cu-LLZO (copper-doped LLZO), a Ta-LLZO (tantalum-doped LLZO), a Sr-LLZO (strontium-doped LLZO) and an Al-LLZO (aluminum-doped LLZO).

15. The method for manufacturing the LCO@oxide@CNT multicomposite cathode material as claimed in claim 1, wherein the LLZO material is formed by a Cuₐ,X_{b}-LLZO, which is a LLZO doped with copper (Cu) and a metal X, wherein X is selected from gallium (Ga), tantalum (Ta), strontium (Sr), barium (Ba) and aluminum (Al), and a>0 and b>0; The Cuₐ,X_{b}-LLZO serves to stabilize an overall structure of composite LCO particles, smooth channels for lithium ions, increase a speed of the oxygen assisted sintering, and reduce producing of lithium carbonate (Li₂CO₃) when the LLZO material is exposed to an air.

16. The method for manufacturing the LCO@oxide@CNT multicomposite cathode material as claimed in claim 15, wherein a+b=0.25˜0.8 and a>0.1.

17. The method for manufacturing the LCO@oxide@CNT multicomposite cathode material as claimed in claim 1, wherein a cross section of the first protruded portion has a curved contour on the surface of the respective large LCO particle; and a cross section of the second protruded portion has a curved contour on the surface of the respective large LCO particle.
